(19) United States
(12) Patent Application Publication
(10) Pub. No.: US 2026/0071522 A1
(43) Pub. Date: Mar. 12, 2026

(54) FRAC WASTEWATER EVAPORATION USING TURBINE EXHAUST HEAT

(71) Applicant: Typhon Technology Solutions (U.S.), LLC, The Woodlands, TX (US)

(72) Inventors: Mahmoud Hajaga Awnour, Richmond, TX (US); Jason David Smith, Conroe, TX (US); Matthew James Vahsholtz, The Woodlands, TX (US); Nicholas Kevin Ruppelt, Houston, TX (US)

(21) Appl. No.: 18/828,194

(22) Filed: Sep. 9, 2024

(51) Int. Cl. E21B 43/26; C02F 1/04; F02C 6/04; C02F 103/10

(52) U.S. Cl. CPC E21B 43/2607; C02F 1/048; F02C 6/04; C02F 2103/10; F05D 2220/76

(57) ABSTRACT

An evaporation system receives exhaust air from a gas turbine. The gas turbine is mounted on a separate mobile power generation transport including the gas turbine and a generator to generate mobile electric power. The evaporation system receives frac wastewater from a wastewater source. The evaporation system sprays the frac wastewater from a plurality of nozzles to generate a spray plume in front of the nozzles. The evaporation system blows the exhaust air into the spray plume to transfer heat from the received exhaust air to the frac wastewater. The heat transfer aids in evaporation of the frac wastewater.

### TECHNICAL FIELD

This disclosure relates generally to hydraulic fracturing fleets, and more specifically to, systems and methods for evaporating frac wastewater using combustion exhaust air discharged from a mobile power generation transport of the frac fleet.

### BACKGROUND

Hydraulic fracturing, or fracking, is a process utilized in the extraction of oil and natural gas stored in deep geologic formations. Fracking methodology involves the injection of high-pressure fluids into a wellbore to create small fractures and fissures in the rock formation. This process enables the natural gas or oil to flow out of the well more freely. One byproduct of hydraulic fracking is generation of frac wastewater.

Frac wastewater includes flowback water and produced water. Flowback water is a mixture of water, sand, and chemicals that come to the surface after a well has been hydraulically fracked. Produced water, on the other hand, is a naturally occurring liquid already in the reservoir. It is brought to the surface with oil and gas removed from the geological formation. During fracking operations, frac wastewater is reused by pumping it back downhole. After several cycles (e.g., after it is too dirty or muddy for reuse), the frac wastewater may be safely discarded. For example, the frac wastewater may be processed by a treatment facility to remove any environmentally harmful or hazardous contaminants and then safely discarded. One method of discarding the frac wastewater involves pumping it downhole into an injection well. Another method is to leave the frac wastewater in a pit to evaporate naturally. However, treatment facilities or injection wells are scarce and not always available at well sites, which are oftentimes at remote locations, away from public infrastructure. Also, natural evaporation is slow and unreliable and poses the problem of soil or groundwater contamination if there is leakage or overflow. The frac wastewater may be transported (e.g., using tank trucks) offsite for safe disposal. However, this leads to increased costs. A more economical and environmentally friendly approach is desirable.

### SUMMARY

In one or more embodiments, an evaporation method includes a plurality of steps. The steps include a step of receiving exhaust air from a gas turbine. The gas turbine is mounted on a separate mobile power generation transport including the gas turbine and a generator to generate mobile electric power. The steps further include a step of receiving frac wastewater from a wastewater source. The steps further include a step of spraying the frac wastewater from a plurality of nozzles to generate a spray plume in front of the nozzles. And the steps further include a step of blowing the exhaust air into the spray plume to transfer heat from the received exhaust air to the frac wastewater, the heat transfer aiding in evaporation of the frac wastewater.

In one or more embodiments, an evaporation system includes an exhaust air connection configured to receive exhaust air from a gas turbine. The system further includes a liquid connection configured to receive a liquid. Still further, the system includes a heat transfer system configured to transfer heat from the received exhaust air to the liquid to aid in evaporation of the liquid.

In one or more embodiments, a hydraulic fracturing system includes a power generation transport including a gas turbine and a generator for generating mobile electric power. The system further includes an exhaust stack coupled to an outlet of the gas turbine, the exhaust stack releasing exhaust air from the gas turbine into atmosphere. In addition, the system includes an exhaust air connection coupled to the exhaust stack. The exhaust air connection discharges a portion of the exhaust air to a heat transfer system. Still further, the system includes a liquid source configured to provide a liquid. The heat transfer system is configured to transfer heat from the exhaust air to the liquid to aid in evaporation of the liquid.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 is a schematic diagram of a mobile hydraulic fracturing system operating at a well site, in accordance with one or more embodiments.

FIG. 2 is a schematic diagram showing components of an evaporation system, in accordance with one or more embodiment.

FIG. 3 is a schematic diagram showing components of an evaporation system, in accordance with one or more embodiments.

FIG. 4 is a schematic diagram showing a spray module, in accordance with one or more embodiments.

FIG. 5 is a schematic diagram showing components of an evaporation system, in accordance with one or more embodiments.

FIG. 6 is a block diagram of a control system of an evaporation system, in accordance with one or more embodiments.

FIG. 7 is a flow chart illustrating a process of evaporating liquid, in accordance with one or more embodiments.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

In the following description, for purposes of explanation, numerous specific details are set forth to provide a thorough understanding of the inventive concept. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the invention, and multiple references to “one embodiment” or “an embodiment” or “another embodiment” should not be understood as necessarily all referring to the same embodiment.

The terms “a,” “an,” and “the” are not intended to refer to a singular entity unless explicitly so defined but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all the alternatives, unless the alternatives are explicitly indicated as mutually exclusive. The phrase “at least one of” when combined with a list of items, means a single item from the list or any combination of items in the list. The phrase does not require all the listed items unless explicitly so defined.

As used herein, the term “transport” refers to any transportation assembly, including, but not limited to, a trailer, truck, skid, and/or barge used to transport heavy structures, such as a gas turbine, a generator, a power generation system, an air handling system, and the like.

As used herein, the term “trailer” refers to a transportation assembly used to transport heavy structures, such as a gas turbine, a generator, a power generation system, an air handling system, and the like, that can be attached and/or detached from a transportation vehicle used to pull or move the trailer. In one embodiment, the trailer may include the mounts and manifold systems to connect the trailer to other equipment.

### Configuration Overview

Conventional evaporation systems involve misting liquid (e.g., water, wastewater, frac wastewater, hydrocarbons, mixture of hydrocarbons and water, produced water, flowback water, and the like) into air and then relying on atmospheric temperature and wind speed to evaporate the liquid. However, such systems are inadequate since the liquid needs to be converted to vapor or steam past its boiling point to evaporate which is difficult to achieve with the atmospheric temperature. Moreover, the wind cools down the liquid's temperature, making it even harder for evaporation to occur.

To overcome the above problem, this disclosure proposes converting spray (e.g., mist) of the liquid to vapor by raising its temperature past the boiling point in a controlled manner using turbine exhaust heat. The pressure of the hot exhaust air further increases the evaporation rate. Techniques disclosed herein efficiently evaporate the liquid throughout the year at a higher rate and in an environmentally friendly manner, irrespective of atmospheric temperature, region, or elevation. More specifically, this disclosure pertains to using waste heat from mobile gas turbines to evaporate excess liquid instead of injecting it back into formations or leaving it in open air pits to evaporate naturally.

In one or more embodiments, the system includes a wastewater pump, an inlet strainer, and turbine flow meter on discharge, injection nozzles, and a steel pipe. The turbine exhaust heat may be redirected via an exhaust connection to a heat transfer system. Nozzles of the heat transfer system may mist the liquid inside and in front of an outlet of the heat transfer system outputting the redirected exhaust air, allowing the high-temperature heat to evaporate the liquid.

In one or more embodiments, the system may include an air-to-liquid heat exchanger to generate a hot liquid using the redirected turbine exhaust heat. For example, the turbine exhaust heat may be directly injected and circulated through the turbine heat exchange system to heat the glycol. Then, a glycol heating loop may be placed at a bottom of a reservoir (e.g., wastewater tank, pit, and the like) to speed up natural evaporation of the wastewater. Additionally, a misting system may be added to further boost the evaporation. In one or more embodiments, the evaporation system may include a shockwave system to increase the wastewater evaporation rate. The shockwave system may include a produced water pump, flow meters, shock wave injection nozzles, an air compressor, a combustion air/carrier air blower, and a natural gas fuel train. The liquid may be pumped and measured with a turbine meter and again through a variable area flow meter to confirm the flow. This liquid may be injected via shockwave nozzles along with compressed air into the firing chamber downstream of the burner. The injection air promotes the atomization of the produced water and forms a specific shape. The hot gas from the flame then vaporizes part of the temporary shape and incinerates the hydrocarbon.

### Example Mobile Hydraulic Fracturing System

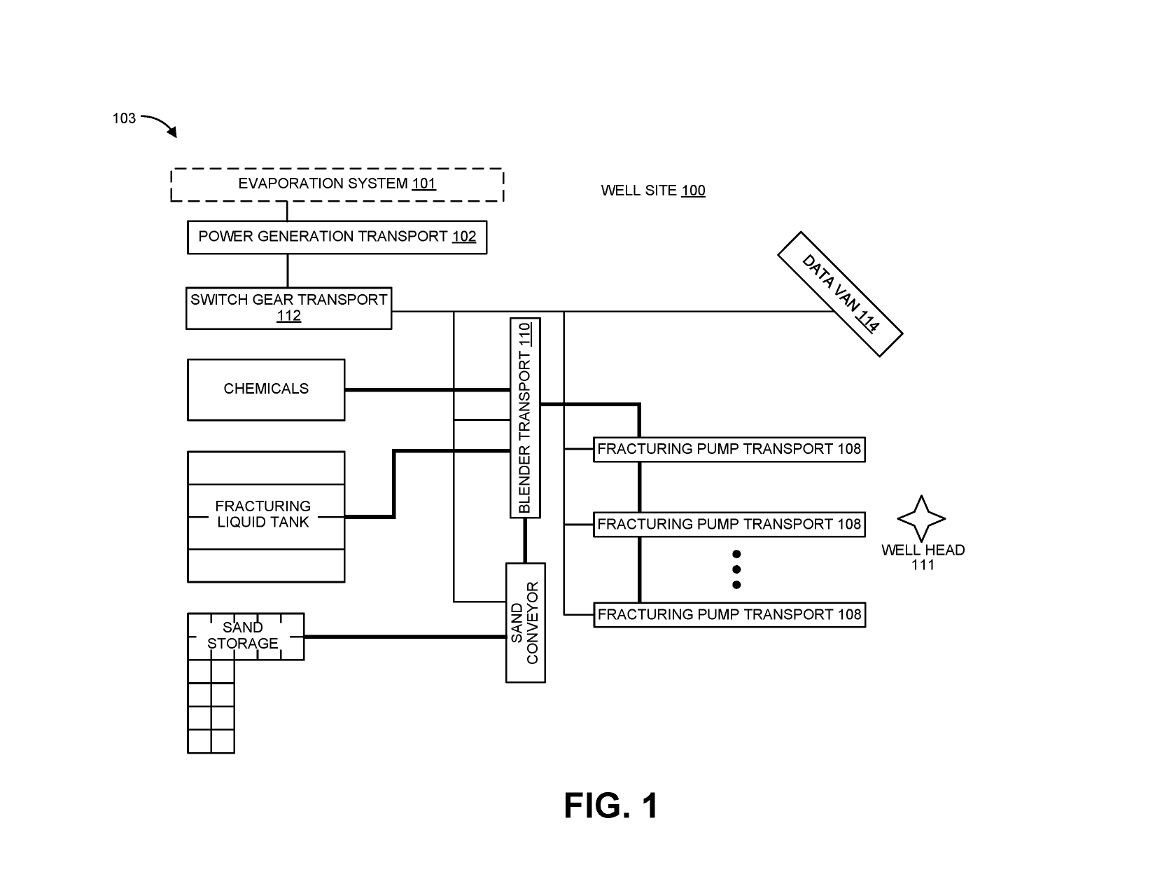

FIG. 1 is a schematic diagram of a mobile hydraulic fracturing system 103 operating at a well site 100, in accordance with one or more embodiments. The well site 100 comprises a wellhead 111 (e.g., frac pad including multiple wells) and the mobile fracturing system 103 (e.g., hydraulic fracturing fleet, frac fleet or system). Generally, the mobile fracturing system 103 may perform fracturing operations to complete a well and/or transform a drilled well into a production well. For example, the well site 100 may be a site where operators are in the process of drilling and completing a well. Operators may start the well completion process (e.g., well completion operation) after drilling, running production casing, and cementing within the wellbore. The operators may also insert a variety of downhole tools into the wellbore and/or as part of a tool string used to drill the wellbore. After the operators drill the well to a certain depth, a horizontal portion of the well may also be drilled and subsequently encased in cement. The operators may subsequently remove the rig, and the mobile fracturing system 103 may be moved onto the well site 100 to perform the well completion operation (e.g., fracturing operation) that forces relatively high-pressure fracturing fluid through the wellhead 111 into subsurface geological formations to create fissures and cracks within the rock. The mobile fracturing system 103 may be moved off the well site 100 once the operators complete the well completion operation. Typically, the well completion operation for the well site 100 may last several days and even up to multiple months.

In one or more embodiments, the mobile fracturing system 103 may comprise a power generation transport 102 (e.g., mobile source of electricity; power generation system; turbine-electric generator transport; inlet and exhaust transport) configured to generate electricity by converting hydrocarbon fuel, such as natural gas, obtained from one or more sources (e.g., a producing wellhead) at the well site 100, from a remote offsite location, and/or another relatively convenient location near the power generation transport 102. That is, the mobile fracturing system 103 may utilize the power generation transport 102 as a power source that burns cleaner while being transportable along with other fracturing equipment. The generated electricity from the power generation transport 102 may be supplied to fracturing equipment to power fracturing operations at one or more well sites, or to other equipment in various types of applications requiring mobile electric power generation.

The power generation transport 102 may be implemented as a single-trailer power generation transport. In one or more embodiments, the power generation transport 102 may be implemented using two or more transports, and components of the power generation transport 102 may be arranged on the two or more transports in any reasonable manner. For example, the power generation transport 102 may be implemented using a two-transport design in which a first transport may comprise a turbine (e.g., gas turbine) and a generator, and a second transport may comprise an air filter box providing filtered combustion air for the turbine, and an exhaust stack that securely provides an exhaust system for combustion exhaust air from the turbine. As another example, the power generation transport 102 may be implemented using a three-transport design in which a first transport may include a gas turbine and an exhaust stack, a second transport may include a generator, and a third transport may include an air handling system that provides filtered intake air for combustion by the turbine. Different configurations (single-trailer, dual-trailer, or three-trailer configurations) of the power generation transport 102 are described in detail in U.S. Patent No. 9,534,473, issued January 3, 2017, to Jeffrey Morris et al and entitled “Mobile Electric Power Generation for Hydraulic Fracturing of Subsurface Geological Formations” (describing a dual-trailer configuration); U.S. Patent No. 11,434,763, issued September 6, 2022, to Jeffrey Morris et al and entitled “Single-Transport Mobile Electric Power Generation” (describing a single-trailer configuration); U.S. Patent No. 11,512,632, issued November 29, 2022, to Jeffrey Morris et al and entitled “Single-Transport Mobile Electric Power Generation” (describing a single-trailer configuration); and U.S. Application Serial No. 17/732,280, filed April 28, 2022, by Jeffrey Morris et al and entitled "Mobile Electric Power Generation System" (describing a three-trailer configuration), each of which is herein incorporated by reference in its entirety.

Although not shown in FIG. 1, the power generation transport or system 102 may include a variety of equipment for mobile electric power generation including a gas conditioning skid, a black start generator, a power source (e.g., gas turbine), a power source air inlet filter housing, a power source inlet plenum, a power source exhaust collector, an exhaust coupling member, a power source exhaust stack, a gearbox, a generator shaft, a generator, a generator air inlet filter housing, a generator ventilation outlet, a generator breaker, a transformer, a starter motor, and a control system. Other components on the power generation transport 102 may include a turbine lube oil system, a fire suppression system, a generator lube oil system, and the like.

In one or more embodiments, the power source may be a gas turbine. In another embodiment, power source may be another type of power source (e.g., diesel engine, internal combustion engine). The gas turbine may generate mechanical energy (e.g., rotation of a shaft) from a hydrocarbon fuel source, such as natural gas, liquefied natural gas, condensate, and/or other liquid fuels. For example, a shaft of the gas turbine may be connected to the gearbox and the generator such that the generator converts the supplied mechanical energy from the rotation of the shaft of the gas turbine to produce electric power. The gas turbine may be a commercially available gas turbine such as a General Electric NovaLT5 gas turbine, a Pratt and Whitney gas turbine, or any other similar gas turbine. The generator may be a commercially available generator such as a Brush generator, a WEG generator, or other similar generator configured to generate a compatible amount of electric power. For example, the combination of the gas turbine, the gearbox, and the generator within power generation transport 102 may generate electric power from a range of at least about 1 megawatt (MW) to about 60 MW (e.g., 5.6 MW, 32 MW, or 48 MW). Other types of gas turbine/generator combinations with power ranges greater than about 60 MW or less than about 1 MW may also be used depending on the application requirement.

In addition to the power generation transport 102, the mobile fracturing system 103 may include a switch gear transport 112, at least one blender transport 110, at least one data van 114, and one or more fracturing pump transports 108 that deliver fracturing fluid through the wellhead 111 to the subsurface geological formations. The switch gear transport 112 may receive electricity generated by the power generation transport 102 via one or more electrical connections. In one embodiment, the switch gear transport 112 may use 13.8 kilovolts (KV) electrical connections to receive power from the power generation transport 102. The switch gear transport 112 may transfer the electricity received from the power generation transport 102 to electrically connected fracturing equipment of the mobile fracturing system 103. The switch gear transport 112 may comprise a plurality of electrical disconnect switches, fuses, transformers, and/or circuit protectors to protect the fracturing equipment. In some embodiments, switch gear transport 112 may be configured to step down a voltage received from the power generation transport 102 to one or more lower voltages to power the fracturing equipment.

As shown in FIG. 1, the mobile fracturing system 103 located at the well site 100 may further include an evaporation system 101. The evaporation system 101 may be configured to couple to a component (e.g., exhaust collector, exhaust stack) disposed downstream to an exhaust of the gas turbine on the power generation transport 102 (e.g., connected to the exhaust stack on the inlet and exhaust transport) in an operation mode to receive a portion of the turbine exhaust heat (i.e., exhaust air) from the gas turbine and utilize the exhaust heat for directly or indirectly evaporating liquid. The evaporation system 101 and the power generation transport 102 may be configured to be connected to each other (e.g., via an exhaust air connection) in an operation mode. One or more components of the evaporation system 101 may be mounted to a transport that may be separately and independently movable relative to the power generation transport 102 in a transportation mode.

The exhaust air received by the evaporation system 101 may be the hot exhaust air released from the exhaust of the gas turbine. Although not specifically shown in FIG. 1, the power generation transport 102 and/or the switch gear transport 112 may also provide electric power (e.g., power generated by the power generation transport 102) to power one or more components of the evaporation system 101. For example, power output from the power generation transport 102 at a relatively high voltage level (e.g., 13.8 KV) may be stepped down using a transformer mounted on the power generation transport 102 or on the switch gear transport 112 to a lower voltage level (e.g., 480 V), and the electric power at the lower voltage level may be output to the evaporation system 101 via an electrical cable connection.

Each fracturing pump transport 108 may receive the electric power from the switch gear transport 112 to power a prime mover. The prime mover converts electric power to mechanical power for driving one or more fracturing pumps of the fracturing pump transport 108. In one embodiment, the prime mover may be a dual shaft electric motor that drives two different frac pumps mounted to each fracturing pump transport 108. Each fracturing pump transport 108 may be arranged such that one frac pump is coupled to opposite ends of the dual shaft electric motor and avoids coupling the pumps in series. By avoiding coupling the pump in series, fracturing pump transport 108 may continue to operate when either one of the pumps fails or has been removed from the fracturing pump transport 108. Additionally, repairs to the pumps may be performed without disconnecting the system manifolds that connect the fracturing pump transport 108 to other fracturing equipment within the mobile fracturing system 103 and the wellhead 111. The fracturing pump transport 108 may implement (in whole or in part) a system for predicting frac pump component life intervals and setting a continuous completion event for a well completion design.

The blender transport 110 may receive electric power fed through the switch gear transport 112 to power a plurality of electric blenders. In one or more embodiments, the blender transport 110 may function independently from the switch gear transport 112 and the power generation transport 102 and be powered by other means such as a diesel engine or a natural gas reciprocating engine. A plurality of prime movers may drive one or more pumps that pump source fluid and blender additives (e.g., sand) into a blending tub, mix the source fluid and blender additives together to form fracturing fluid, and discharge the fracturing fluid to the fracturing pump transports 108. In one embodiment, the electric blender may be a dual configuration blender that comprises electric motors for the rotating machinery that are located on a single transport. In another embodiment, a plurality of enclosed mixer hoppers may be used to supply the proppants and additives into a plurality of blending tubs.

The data van 114 may be part of a control network system, where the data van 114 acts as a control center configured to monitor and provide operating instructions to remotely operate the evaporation system 101, the blender transport 110, the power generation transport 102, the fracturing pump transports 108, and/or other fracturing equipment within the mobile fracturing system 103. For example, the data van 114 may implement (in whole or in part) the control system for managing one or more heat transfer (e.g., air-to-liquid heat transfer, or liquid-to-air heat transfer) operations according to the present disclosure. In one embodiment, the data van 114 may communicate with the variety of fracturing equipment using a control network system that has a ring topology (or star topology). A ring topology may reduce the amount of control cabling used for fracturing operations and increase the capacity and speed of data transfers and communication.

Other fracturing equipment shown in FIG. 1, such as fracturing liquid (e.g., water) tanks, chemical storage of chemical additives, hydration unit, sand conveyor, and sandbox storage are known by persons of ordinary skill in the art, and therefore are not discussed in further detail. In one or more embodiments of the mobile fracturing system 103, one or more of the other fracturing equipment shown in FIG. 1 may be configured to receive power generated from the power generation transport 102. The control network system for the mobile fracturing system 103 may remotely synchronize and/or slave the electric blender of the blender transport 110 with the electric motors of the fracturing pump transports 108.

### Example Evaporation System

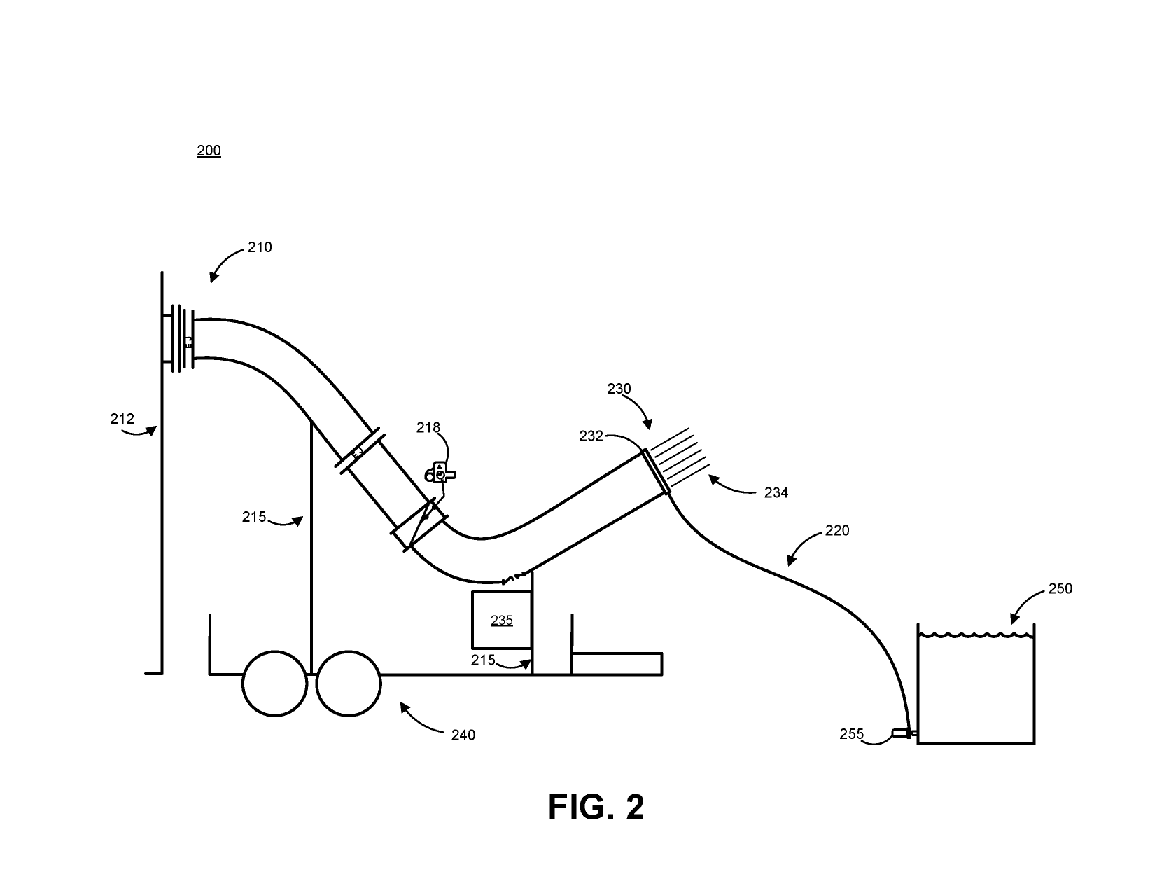

FIG. 2 is a schematic diagram showing components of an evaporation system 200, in accordance with one or more embodiments. FIG. 2 shows that the evaporation system 200 includes an exhaust air connection 210, a liquid connection 220, and a heat transfer system 230. FIG. 2 also shows that at least some of the components of the evaporation system 200 may be mounted to an evaporation transport 240 to impart mobility to the evaporation system 200.

In FIG. 2, the exhaust air connection 210 is detachably connected to an exhaust stack 212 (e.g., the exhaust stack of the gas turbine mounted on the power generation transport 102 in FIG. 2) during an operation mode. In one or more embodiments, in an operation mode, the evaporation transport 240 may be positioned at a predetermined orientation and distance relative to the power generation transport 102 (e.g., the inlet and exhaust transport in a two-trailer configuration of a power generation system) such that the exhaust air connection 210 can be connected to the exhaust stack 212. FIG. 2 illustrates that the exhaust air connection 210 routes a portion of the exhaust air from the gas turbine to the heat transfer system 230 for liquid evaporation, while a remainder of the exhaust air from the gas turbine is released into atmosphere by the exhaust stack 212.

The exhaust air connection 210 may be implemented using any type of connection mechanism, e.g., a flange connection, eductor connection, and the like. The exhaust air connection 210 may include one or more components, e.g., S-joints, flex joints, fixed pipes (e.g., 24-inch 316 stainless steel pipe) to receive hot exhaust air from the exhaust stack 212 and provide the hot exhaust air to the heat transfer system 230. FIG. 2 also shows that the exhaust air connection 210 is supported by piles or beams 215 to fixedly mount the exhaust air connection 210 to the evaporation transport 240.

One or more sensors may be mounted along an exhaust air flow path from the exhaust air connection 210 to the heat transfer system 230. FIG. 2 illustrates an embodiment where one or more sensors 218 (e.g., a flowmeter, a temperature sensor) are mounted on the flow path to detect, e.g., a flow rate, a temperature, and the like, of the exhaust air flowing from the exhaust stack 212 to the heat transfer system 230.

FIG. 2 further shows that a liquid connection 220 may connect a liquid source 250 to the heat transfer system 230. The liquid source 250 may be a tank, reservoir, open air pit, tanker truck, and the like. In one or more embodiments, the liquid stored at the liquid source 250 may be frac wastewater. FIG. 2 shows that a pump (e.g., submersible pump) 255 is disposed at the liquid source 250 to pump the liquid from the liquid source 250 to the heat transfer system 230. Although not shown in FIG. 2, the evaporation system 200 may include one or more filters to remove solid contaminants (e.g., sand, proppants, and the like) from the liquid. The filters may be disposed upstream and/or downstream of the pump 255. Further, although not shown in FIG. 2, the evaporation system 200 may include one or more sensors at the liquid source 250 and/or at one or more positions along the liquid connection 220 to detect one or more properties of the liquid (e.g., flow rate, temperature, pressure, density, and the like) flowing through the liquid connection 220.

The heat transfer system 230 may transfer heat from the exhaust air received via the exhaust air connection 210 to the liquid received via the liquid connection 220 to aid in evaporation of the liquid. FIG. 2 shows that a control panel 235 may be operable to control operation of the heat transfer system 230. The heat transfer system 230 may operate as a heat exchanger to transfer the heat of the exhaust air to the liquid received via the liquid connection 220 to evaporate the liquid. For example, the heat transfer system 230 may include an outlet (e.g., open end of a pipe) and a spray module 232 disposed at a proximal end of the outlet or inside the outlet to spray the liquid received by the liquid connection 220 and generate a spray plume 234 in front of the outlet. The heat transfer system 230 transfers the heat from the received exhaust air to the liquid by blowing the exhaust air into the spray plume 234 as shown in FIG. 2.

A byproduct of the power generation transport (e.g., inlet and exhaust transport) 102 is exhaust air that can range from about 600 degrees Fahrenheit (° F.) to about 1300° F. (e.g., about 315 degrees Celsius (° C.) to about 704° C.). In the operation mode, the evaporation transport may be positioned adjacent to the power generation transport 102 and connected via the exhaust air connection 210 to receive some of (e.g., a portion of) of the hot exhaust air output from the power generation transport 102. The hot exhaust air may cause evaporation of some or most of the liquid in the spray plume 234 thereby disposing of the frac wastewater in an environmentally friendly manner.

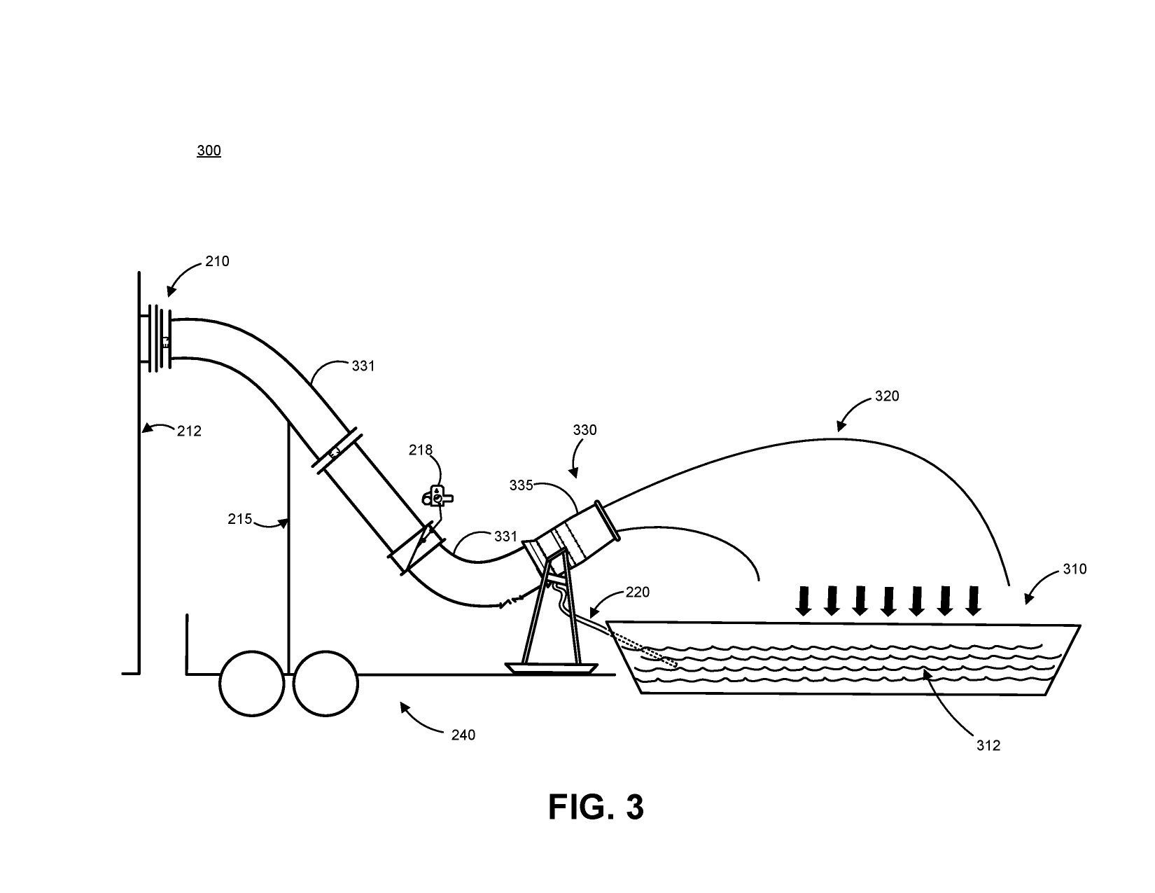

FIG. 3 is a schematic diagram showing components of an evaporation system 300, in accordance with one or more embodiments. Components of the evaporation system 300 of FIG. 3 that are similar to components of the evaporation system 200 of FIG. 2 are represented using the same reference numerals and detailed description of the components is omitted. FIG. 3 shows an embodiment where the liquid source is an open-air pit 310 that receives the frac wastewater 312 for processing. Conventionally, the frac wastewater 312 in the liquid source 310 may be disposed by pumping it downhole into an injection well or pumping it to a treatment facility. Alternately, the frac wastewater 312 may be sprayed using a misting system to aid in evaporation of the wastewater 312. However, such methods have limitations including slow evaporation time and are unable to process large volumes of wastewater quickly. This may also lead to contamination of groundwater due to the wastewater 312 remaining in the pit 310 for extended periods. To overcome these problems, as shown in FIG. 3, the evaporation system 300 includes a heat transfer system 330 that transfers heat from the exhaust air received via the exhaust air connection to the frac wastewater 312 received via the liquid connection 220.

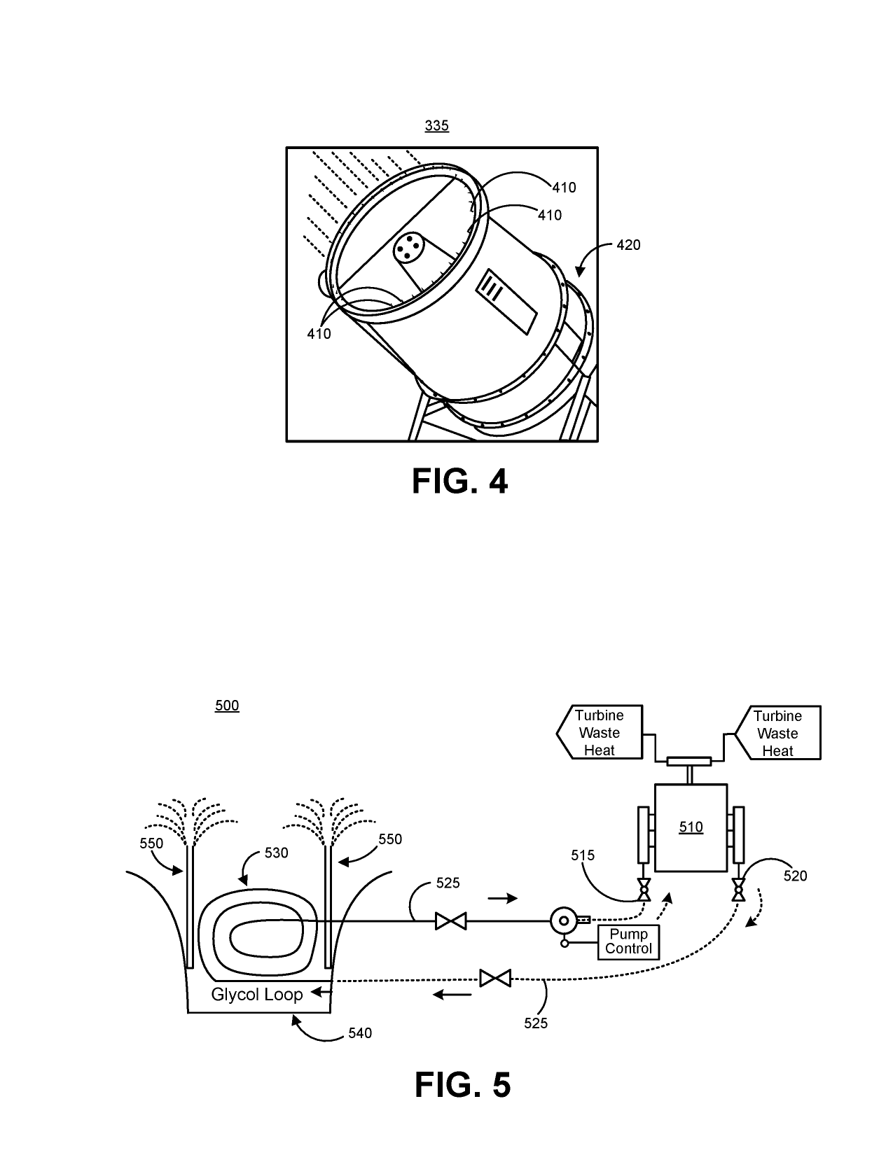

FIG. 3 shows that the heat transfer system 330 includes a spray module 335 that is adapted to spray the frac wastewater received by the liquid connection 220 to generate a spray plume 320 in front of the spray module. The spray module 335 of FIG. 3 is shown in more detail in FIG. 4.

FIG. 4 shows that the spray module 335 include a plurality of nozzles 410. As shown in FIG. 4, the nozzles 410 may be mounted circumferentially along a periphery of an opening (e.g., outlet) of the spray module 335. A pump of the heat transfer system 330 may pump the wastewater 312 from the pit 310 and via the liquid connection 220 to the spray module 335. The pump may cause the liquid to be discharged from the plurality of nozzles 410 at a high pressure to convert the liquid into a spray or fine mist that forms a spray plume 320 that extends into the air and over the water pit 310. The spray module 335 of FIG. 4 may further include one or more blowers (e.g., fans) 420 inside a main body thereof to receive the hot exhaust air from the exhaust air connection 210 and via the pipe 331 and cause the forced fan air to be discharged from the opening of the spray module 335 where the nozzles 410 are disposed to cause the hot exhaust air to come into contact with the spray or mist droplets in the spray plume 320 to thereby transfer thermal energy from the hot exhaust air to the wastewater 312. The thermal energy transfer causes the temperature of the wastewater 312 droplets to rise, thereby aiding in faster evaporation of the wastewater 312. Water in the spray plume 320 that does not convert into vapor may fall back down into the pit 310 and may be pumped out via the liquid connection 220 again to be discharged by the spray module 335 and evaporated. Since the water temperature of wastewater 312 in the pit 310 rises due to the operation of the spray module 335, the speed of evaporation of the water 312 is increased substantially using turbine exhaust heat that is already available as a byproduct of the mobile power generation operation of the gas turbine at the wellsite. Although the embodiments of FIGS. 3-4 show one spray module 335, the heat transfer system 330 may include a plurality of such spray modules 335 positioned along a bank of the wastewater pit 310, each spray module 335 receiving the hot exhaust air from the gas turbine and the wastewater 312 from the pit 310, generating the spray plumes, and blowing the hot exhaust air into the spray plumes to simultaneously evaporate the wastewater using the plurality of spray modules 335.

FIG. 5 is a schematic diagram showing components of an evaporation system 500, in accordance with one or more embodiments. FIG. 5 illustrates an alternate embodiment where the turbine exhaust heat received by the exhaust air connection may be routed to a heat transfer assembly 510 that uses the hot exhaust air to perform an air-to-liquid heat exchange operation.

The heat transfer assembly 510 may be disposed on a heat recovery flow path to receive the hot exhaust air and extract thermal energy from the hot exhaust air by causing the hot exhaust air to contact with one or more heat conducting elements, such as heat exchanger coils, disposed within the heat transfer assembly 510. The evaporation system 500 may include a fluid source (not shown) that may store source fluid which may include, but is not limited to, water, or a water glycol mixture (e.g., 50% water, 50% glycol). Other fluids that have a high heat thermal transfer index can also be used as the source fluid.

In one or more embodiments, transfer lines for the source fluid may be insulated. The fluid source may correspond to any type of storage tank (e.g., container, bin, etc.) for storing the source fluid and that can handle the heated source fluid. An outlet of the fluid source may connect to an inlet 515 to the heat conducting elements of the heat transfer assembly 510. After passing through the heat transfer assembly 510 and absorbing the thermal energy, the heated source fluid may be discharged from an outlet 520 of the heat transfer assembly 510 and sent to one or more destinations. For example, FIG. 5 shows a configuration where the heated source fluid lines 525 form a loop 530 in a frac wastewater tank 540 to heat the wastewater in the tank 540, thereby accelerating its evaporation. After transferring the thermal energy to the wastewater in the water tank 540 from the heated source fluid circulating in the lines 525 at the loop 530, the source fluid returns to the inlet 515 to again enter the heat transfer assembly 510 and get reheated in a continuous closed loop. That is, the embodiment in FIG. 5 illustrates a configuration where the source fluid may circulate in a closed loop from the outlet 520 of the heat transfer assembly 510 back to the inlet 515. In one or more embodiments, the source fluid may also flow through the heat transfer assembly 510 in an open loop configuration. That is, for example, the source fluid may be water or other mixture of one or more liquids (e.g., frac fluid, wastewater), and the heat transfer assembly 510 may heat the liquid as it passes through the heat transfer assembly 510 in a “one-way” configuration. In one or more embodiments, the evaporation system 500 may also include one or more spray modules 550 to further accelerate the evaporation of the heated wastewater in the tank 540 by spraying or misting the heated water into the air and generating spray plumes that further accelerate wastewater evaporation.

### Example Control System

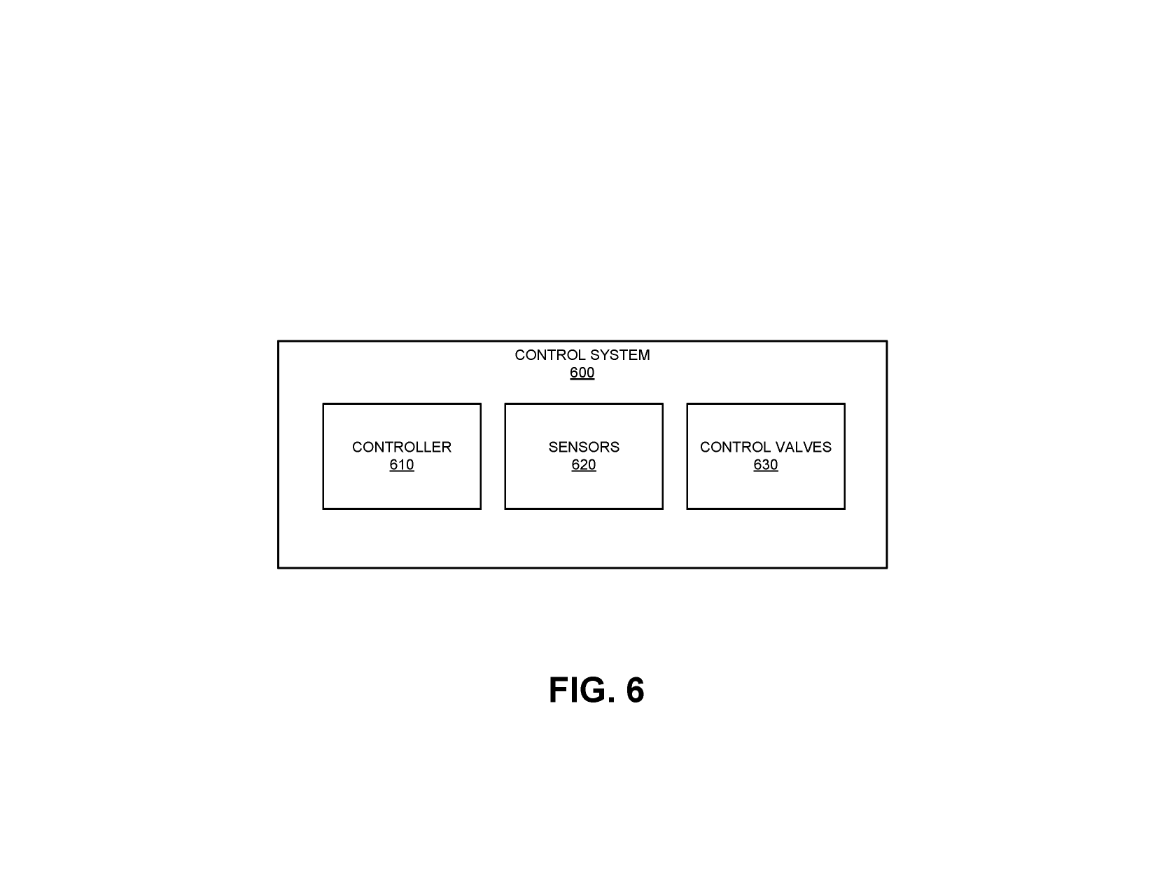

FIG. 6 is a block diagram of a control system 600 of an evaporation system, in accordance with one or more embodiments. The control system 600 illustrated in FIG. 6 may be operable with any of the illustrated evaporation systems (e.g., system 101, 200, 300, 500) according to the present disclosure. The evaporation system receives exhaust air (e.g., via the exhaust air connection 210) from, e.g., an exhaust stack of the inlet and exhaust transport (e.g., power generation transport 102), where the exhaust air ranges in temperature from about 600° F. to about 1300° F. One of the reasons the turbine-electric generator transport produces exhaust air with varying temperatures is because of the varying load the turbine-electric generator transport supplies power to. Moreover, the exhaust air flow rate for the turbine-electric generator transport may also vary depending on the amount of power load.

For example, when the gas turbine is at a zero percent power load, the temperature of the exhaust air could be about 600° F. and have an exhaust air flow rate of about 180,000 pounds per hour (lbs/hr). If the gas turbine is operating at a 60 percent power load, the temperature of the exhaust air is about 880° F. with an exhaust air flow rate of about 570000 (lbs/hr). That is, the temperature and flow rate of the exhaust air varies depending on the power load.

In one or more embodiments, the control system 600 includes a controller 610, sensors 620, and one or more valves 630. The sensors 620 (e.g., flow rate sensors, pressure sensors, temperature sensors, weather station, wind speed, wind direction, and the like) may measure various metrics like the temperature and/or flow rate of the gas turbine exhaust air at one or more points along the exhaust air flow path for the gas turbine exhaust air (e.g., at the exhaust air connection), the temperature and/or flow rate of the liquid received for evaporation from the liquid connection, the temperature and/or flow rate of the source fluid (e.g., liquid-glycol mixture) at the inlet and/or the outlet of the air-to-liquid heat exchanger or at other points along the closed loop for the source fluid, weather conditions like wind direction, wind speed, ambient temperature, precipitation, and the like.

The controller 610 (e.g., programmable logic controller) may be configured to control an operation of the evaporation system based on the sensor data detected by one or more of the sensors 620. For example, the sensors 620 may detect an operation state of the gas turbine (e.g., on-state, off-state, current temperature and/or flow rate of the exhaust air) and the controller 610 may be configured to change a flow rate of the liquid flowing through the heat transfer system based on the operation state of the gas turbine. For example, the controller 610 may ramp up the liquid flow rate flowing into the evaporation system for evaporation as the temperature and/or the flow rate of the exhaust air ramps up. Conversely, the controller 610 may ramp down the liquid flow rate flowing into the evaporation system for evaporation as the temperature and/or the flow rate of the exhaust air ramps down. The controller 610 may include control logic and corresponding temperature and flow rate thresholds to implement the ramp up and ramp down evaporation operations. In one or more embodiments, the evaporation system may include a plurality of spray modules and the controller 610 may be configured to automatically bring one or more spray modules online or gradually take gradually and automatically them offline, as the exhaust air flow rate and temperature ramps up or down. If the controller 610 determines that the gas turbine is in an off state, the controller 610 may automatically turn off the operation of the evaporation system. And conversely, when the controller 610 determines that the gas turbine is in an on-state, the controller 610 may automatically turn on the operation of the evaporation system. The system may thus optimize use of the exhaust heat, based on how much heat energy is available for evaporation and based on the temperature and flow rate or volume of the liquid flowing through the evaporation system, such that predetermined evaporation states or thresholds are achieved.

As another example, the sensors 620 may detect weather conditions (i.e., ambient environment conditions) and control the operation state of the evaporation system based on the weather data. For example, if the current weather conditions indicate it is raining, the controller 610 may automatically turn off the evaporation operation of the evaporation system. As another example, if the wind direction and/or wind speed is not within a target range (e.g., a predefined angular range relative to a spray module), the controller 610 may automatically stop the operation of the evaporation system. That is, if the wind direction and/or wind speed will cause the spray plume to blow in an undesirable direction (e.g., direction away from the wastewater pit), the controller 610 may automatically detect this condition based on the sensor data and may automatically shut off the operation of the evaporation system. As another example, the controller 610 may regulate the waste liquid flow rate and/or regulate the operation of the blowers or pumps generating the spray plume based on the weather data to ensure the spray plume and hot exhaust air flows stay within desired ranges or areas.

The control valves 630 may be operable by the controller 610 to control one or more characteristics of the evaporation system. For example, the controller 610 may automatically operate (e.g., via actuators, electric motors) a control valve to regulate the flow rate of the exhaust air flowing into the evaporation system. As another example, the controller 610 may automatically operate another control valve to regulate a flow rate of the waste liquid flowing into the evaporation system for evaporation. As yet another example, the controller 610 may automatically operate other control valves to regulate a flow rate of the source fluid flowing through the air-to-liquid heat exchanger system of the evaporation system.

### Example Evaporation Method

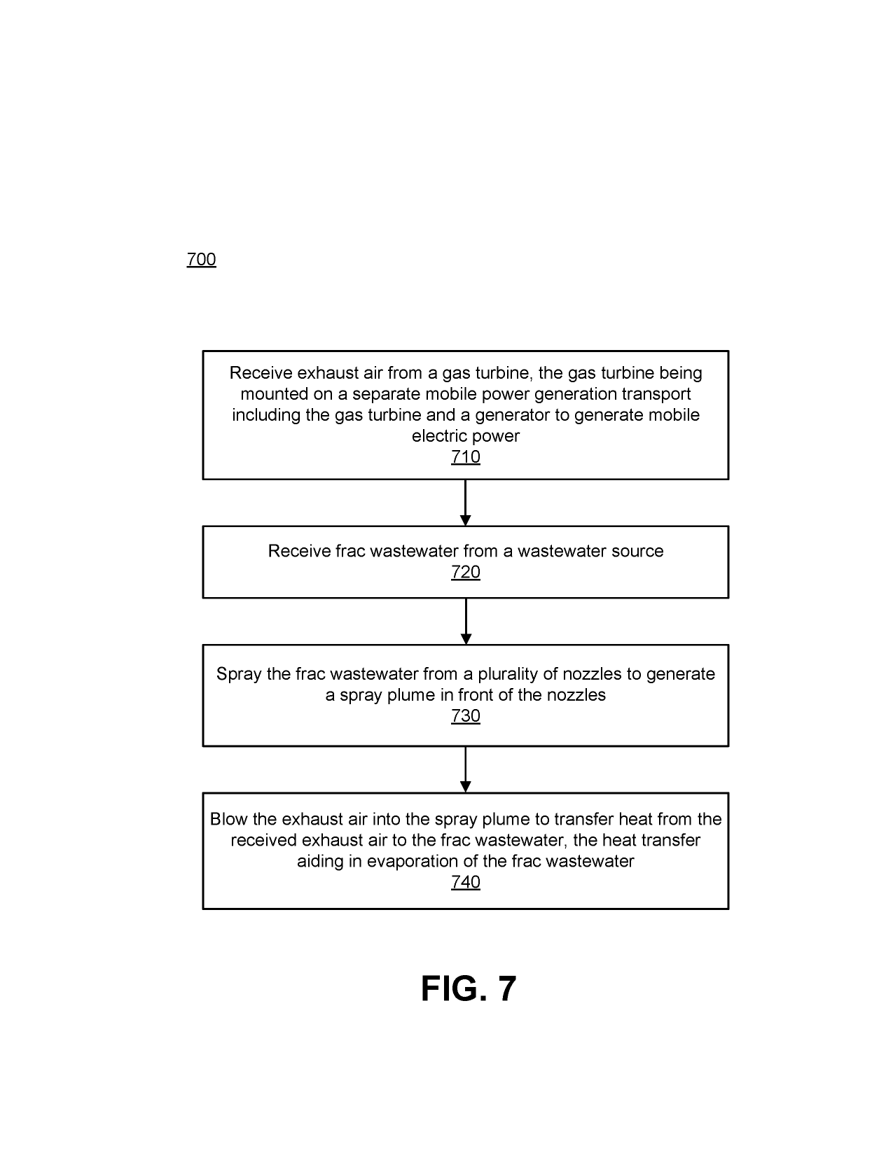

FIG. 7 is a flow chart illustrating a process 700 of evaporating liquid, in accordance with one or more embodiments.

In one or more embodiments, after a frac fleet has been transported to a well site and converted to an operation mode, the fleet may start producing frac wastewater that may be stored in an open-air pit at the wellsite. To dispose this wastewater, the frac fleet may include an evaporation system configured to perform a plurality of operations illustrated in process 700.

The method begins with the evaporation system receiving 710 exhaust air from a gas turbine, the gas turbine being mounted on a separate mobile power generation transport including the gas turbine and a generator to generate mobile electric power. For example, as shown in FIGS. 1-3, the evaporation system (101, 200, 300) may include an exhaust air connection that is coupled to an exhaust stack of a gas turbine in an operation mode. The evaporation system may receive a portion of the hot exhaust air discharged from the gas turbine via the exhaust air connection.

The evaporation system receives 720 frac wastewater from a wastewater source. For example, as shown in FIGS. 2-3, the wastewater source may be a tank, a reservoir, an openair water pit or pond, and the like. The system may include a pump (e.g., a submersible pump in the pit operating at around 120 gallons per minute and 100 pounds per square inch) to transmit the wastewater to be evaporated from the water source to the heat transfer apparatus of the evaporation system.

The evaporation system may include one or more spray modules to spray 730 the frac wastewater received at step 720 from a plurality of nozzles of the spray modules to generate spray plumes in front of the spray modules. In one or more embodiments, the wastewater may be filtered using one or more filter stages before spraying the wastewater from the nozzles. For example, as shown in FIG. 3, by forcing the wastewater out of nozzles of the spray module at a high pressure and flow rate (e.g., 120 GPM at 100 psi), the system generates a spray plume of tiny droplets of the wastewater that are more readily evaporable.

The system then blows 740 the exhaust air into the spray plume to transfer heat from the received exhaust air to the frac wastewater, the heat transfer aiding in evaporation of the frac wastewater. For example, the system may employ blowers (e.g., fans) to generate forced fan air that includes the hot exhaust air received at step 710. The system may blow this hot air into the plume generated at block 730 to transfer heat energy of the exhaust air to the water droplets, aiding in their evaporation. In one or more embodiments, as explained in connection with FIG. 5, the evaporation system and method 700 may be a “smart system” which utilizes sensors and a controller to automatically control operation and operation parameters of the system based on sensor data.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. An evaporation system, comprising:
an exhaust air connection configured to receive exhaust air from a gas turbine;
a liquid connection configured to receive a liquid; and
a heat transfer system configured to transfer heat from the received exhaust air to the liquid to aid in evaporation of the liquid.

2. The evaporation system of claim 1, wherein the gas turbine is mounted on a separate mobile power generation transport including the gas turbine and a generator to generate mobile electric power.

3. The evaporation system of claim 2, wherein the exhaust air connection is coupled to an exhaust stack connected to the gas turbine, and wherein the exhaust air connection routes a portion of the exhaust air from the gas turbine to the heat transfer system for liquid evaporation, a remainder of the exhaust air from the gas turbine being released into atmosphere from the exhaust stack.

4. The evaporation system of claim 3, wherein the exhaust stack is mounted on a separate air handling transport, and wherein the exhaust stack is coupled to an outlet of the gas turbine on the power generation transport in an operation mode.

5. The evaporation system of claim 1, wherein the heat transfer system includes a spray module that is adapted to spray the liquid received by the liquid connection to generate a spray plume in front of the spray module, and wherein the heat transfer system transfers the heat from the received exhaust air to the liquid by blowing the exhaust air into the spray plume.

6. The evaporation system of claim 5, wherein the spray module includes a plurality of nozzles, and wherein the heat transfer system further includes one or more blowers disposed upstream of the nozzles, the blowers blowing the exhaust air into the spray plume to aid in evaporation of the liquid.

7. The evaporation system of claim 6, wherein the heat transfer system includes an outlet to discharge the exhaust air, the plurality of nozzles located at the outlet.

8. The evaporation system of claim 6, wherein the liquid received by the liquid connection is frac wastewater produced as a byproduct from a hydraulic fracturing operation.

9. The evaporation system of claim 8, wherein the heat transfer system further includes a filter to filter out solid contaminants from the frac wastewater prior to the frac wastewater being discharged from the nozzles.

10. The evaporation system of claim 1, further comprising:
a reservoir to store the liquid, wherein the heat transfer system includes a pump to pressurize the liquid from the reservoir and discharge the pressurized liquid from a plurality of nozzles at a predetermined flow rate.

11. The evaporation system of claim 10, wherein the heat transfer system includes an air-to-liquid heat exchanger to generate hot liquid from the received exhaust air, the heat exchanger being disposed in the reservoir to heat the liquid in the reservoir, the evaporation system further comprising:
a spray system to spray the heated liquid in the reservoir into air to aid in evaporation of the liquid in the reservoir.

12. The evaporation system of claim 1, further comprising:
a controller; and
one or more sensors that generate sensor data, wherein the controller controls an operation of the evaporation system based on the sensor data.

13. The evaporation system of claim 12, wherein the one or more sensors detect an operation state of the gas turbine, and wherein the controller configures a flow rate of the liquid flowing through the heat transfer system based on the operation state of the gas turbine.

14. The evaporation system of claim 12, wherein the one or more sensors detect a flow rate and a temperature of the exhaust air received by the exhaust air connection, and wherein the controller configures a flow rate of the liquid flowing through the heat transfer system based on the flow rate and the temperature of the exhaust air.

15. The evaporation system of claim 12, wherein the one or more sensors detect ambient environment conditions, and wherein the controller stops the operation of the evaporation system based on the ambient environment conditions.

16. The evaporation system of claim 15, wherein the ambient environment conditions include wind direction or wind speed, and wherein the controller stops the operation of the evaporation system if the wind direction or wind speed is outside a target range.

17. The evaporation system of claim 15, wherein the ambient environment conditions include precipitation.

18. An evaporation method, comprising:
receiving exhaust air from a gas turbine, the gas turbine being mounted on a separate mobile power generation transport including the gas turbine and a generator to generate mobile electric power;
receiving frac wastewater from a wastewater source;
spraying the frac wastewater from a plurality of nozzles to generate a spray plume in front of the nozzles; and
blowing the exhaust air into the spray plume to transfer heat from the received exhaust air to the frac wastewater, the heat transfer aiding in evaporation of the frac wastewater.

19. The evaporation method of claim 18, wherein receiving the frac wastewater comprises operating a pump, and wherein the method further comprises:
determining an operation state of the gas turbine; and
operating the pump and spraying the frac wastewater based on the operation state of the gas turbine.

20. A hydraulic fracturing system, comprising:
a power generation transport including a gas turbine and a generator for generating mobile electric power;
an exhaust stack coupled to an outlet of the gas turbine, the exhaust stack releasing exhaust air from the gas turbine into atmosphere;
an exhaust air connection coupled to the exhaust stack, the exhaust air connection discharging a portion of the exhaust air to a heat transfer system; and
a liquid source configured to provide a liquid;
wherein the heat transfer system is configured to transfer heat from the exhaust air to the liquid to aid in evaporation of the liquid.
